(19) United States
(12) Patent Application Publication
(10) Pub. No.: US 2026/0178912 A1
(43) Pub. Date: Jun. 25, 2026

(54) METHOD FOR MODELING TRAINING, HOST AND STORAGE APPARATUS

(71) Applicant: SAMSUNG ELECTRONICS CO., LTD., Suwon-si (KR)

(72) Inventors: Ziyan ZHAO, Suwon-si (KR); Beomsig CHO, Suwon-si (KR); Dan CAO, Suwon-si (KR); Kun DOU, Suwon-si (KR)

(73) Assignee: SAMSUNG ELECTRONICS CO., LTD., Suwon-si (KR)

(21) Appl. No.: 19/013,596

(22) Filed: Jan. 8, 2025

(30) Foreign Application Priority Data
Dec. 19, 2024 (CN) 202411885243.8

(51) Int. Cl. G06N 3/084; G06T 1/60

(52) U.S. Cl. CPC G06N 3/084; G06T 1/60

(57) ABSTRACT

The present disclosure provides a method for model training, a host, and a storage apparatus. The method may include instructing, by a host apparatus to a graphics processing unit (GPU), to load first intermediate data of a current layer of a model from a dynamic random access memory (DRAM) of a storage apparatus into a memory of the GPU, wherein the current layer is a layer of the model for which computation is being performed; and notifying, the host apparatus to the storage apparatus, to prefetch second intermediate data of a layer of the model to be computed from NAND of the storage apparatus into the DRAM of the storage apparatus based on a space capacity of the DRAM, wherein the first intermediate data of the current layer is used by the GPU in backward propagation of the model to perform the computation for the current layer.

### CROSS-REFERENCES TO RELATED APPLICATION

The present application is a continuation of International application No. 202411885243.8, filed on Dec. 19, 2024, at the Chinese Intellectual Property Office, the disclosure of which us incorporated herein in its entirety.

### BACKGROUND

The present disclosure relates to a field of artificial intelligence, and more particularly, to a method for modeling and training a host and a storage apparatus.

With the development of an artificial intelligence (AI) technology, models become larger and larger, the demand for graphics processing unit (GPU) memory increases. In order to obtain the large models with higher model accuracy and faster network convergence speed, the training requires deeper network depth and larger training samples (batch size), which may be limited by the memory capacity associated with GPUs, which is often referred to as the “memory wall” problem.

### SUMMARY

The present disclosure provides a method for modeling training, a host and a storage apparatus to address a part of or all the problems described above.

According to an aspect of the disclosure, a method for model training is provided. The method may include, instructing, by a host apparatus to a graphics processing unit (GPU), to load first intermediate data of a current layer of a model from a dynamic random access memory (DRAM) of a storage apparatus into a memory of the GPU, wherein the current layer is a layer of the model for which computation is being performed; and notifying, the host apparatus to the storage apparatus, to prefetch second intermediate data of a layer of the model to be computed from NAND of the storage apparatus into the DRAM of the storage apparatus based on a space capacity of the DRAM, wherein the first intermediate data of the current layer is used by the GPU in backward propagation of the model to perform the computation for the current layer.

In an embodiment, the prefetching of the second intermediate data is performed at least partially in parallel with the computation for the current layer.

In an embodiment, the instructing the storage apparatus to prefetch the second intermediate data may include traversing the layer of the model to be computed as a prefetch layer, and notifying the storage apparatus to prefetch the second intermediate data for the prefetch layer based on the DRAM having remaining space and the prefetching of the second intermediate data having not been performed for the prefetch layer.

In an embodiment, the method may further include instructing, in forward propagation of the model, the GPU to offload third intermediate data generated by the computation for the layer of the model from the memory of the GPU into the NAND of the storage apparatus

In an embodiment, the method may further include obtaining, prior to model training, information of the layer for which the third intermediate data is offloaded into the NAND based on memory capacity of the GPU and execution time of the forward propagation, wherein the layer is one of a plurality of layers of the model; wherein the instructing of the GPU to offload the third intermediate data in the forward propagation of the model may include instructing, in the forward propagation of the model based on the information of the layer, the GPU to offload the third intermediate data.

In an embodiment, the obtaining of the information of the layer for which the third intermediate data is offloaded into the NAND among the plurality of the layers of the model based on the memory capacity of the GPU and the execution time of the forward propagation may include deriving the information of the layer based on a total amount of remaining intermediate data being less than or equal to the memory capacity of the GPU and a total offloading time being less than or equal to the execution time of the forward propagation, wherein the total amount of the remaining intermediate data is based on an amount of fourth intermediate data of layers of the plurality of layers of the model other than the layer for which the third intermediate data is offloaded into the NAND, and wherein the total offloading time is based on offloading time of the layer for which the third intermediate data is offloaded into the NAND.

In an embodiment, the first intermediate data comprises activation values, and the computation for the current layer comprises gradient computation with respect to the activation values.

According to an aspect of the disclosure, a method for model training is provided, the method is applied to a storage apparatus which comprises a dynamic random access memory (DRAM) and NAND, the method includes receiving, by a storage apparatus, a notification for performing a data prefetching operation from a host, wherein the storage apparatus comprises a dynamic random access memory (DRAM) and NAND, and prefetching, by the storage apparatus, intermediate data of a layer of a model to be computed from the NAND into the DRAM based on the received notification.

In an embodiment, the method further includes transmitting intermediate data of a current layer of the model to a memory of a graphics processing unit (GPU), wherein the current layer of the model is a layer of the model for which computation is being performed, wherein the intermediate data of the current layer is stored in the DRAM, and wherein the intermediate data of the current layer is used by the GPU in backward propagation of the model to perform the computation for the current layer.

In an embodiment, the prefetching of the intermediate data of the layer and the computation for the current layer are performed at least partially in parallel.

In an embodiment, the method further includes receiving, in forward propagation of the model, second intermediate data of the layer, the second intermediate data of the layer being data generated by the computation for the layer of the model offloaded from the memory of the GPU to be stored into the NAND.

In an embodiment, the transmitting of the intermediate data of the current layer stored in the DRAM to be loaded into the graphics processing unit (GPU) memory includes transmitting, based on a compute express link (CXL) protocol, the intermediate data of the current layer stored in the DRAM to the memory of the GPU; wherein the receiving of the second intermediate data of the layer includes receiving, based on the CXL protocol, the second intermediate data of the layer that is generated by the computation offloaded from the memory of the GPU to be stored into the NAND.

In an embodiment, wherein the storage apparatus further comprises a memory-semantics solid state drive (MS SSD).

According to an aspect of the disclosure, a host is provided, the host comprises: a memory, storing instructions; and a processor configured to execute the instructions to instruct a graphics processing unit (GPU) to load first intermediate data of a current layer of a model from a dynamic random access memory (DRAM) of a storage apparatus into a memory of the GPU, wherein the current layer is a layer of the model for which computation is being performed; and notify, based on space capacity of the DRAM, the storage apparatus to prefetch second intermediate data of a layer of the model to be computed from NAND of the storage apparatus into the DRAM, wherein the first intermediate data of the current layer is used by the GPU in backward propagation of the model to perform the computation for the current layer.

In an embodiment, the prefetching the second intermediate data of the layer and the computation for the current layer are performed at least partially in parallel.

In an embodiment, the processor is further configured to execute the instructions to: traverse the layer of the model to be computed as a prefetch layer, and notifying the storage apparatus to prefetch the second intermediate data for the prefetch layer based on the DRAM having remaining space and the prefetching of the second intermediate data having not been performed for the prefetch layer.

In an embodiment, the processor is further configured to execute the instructions to: instruct, in forward propagation of the model, the GPU to offload third intermediate data generated by the computation for the layer of the model from the memory of the GPU into the NAND.

In an embodiment, the processor is configured to obtain, prior to the model training, information of the layer for which the intermediate data is offloaded into the NAND among a plurality of layers of the model based on memory capacity of the GPU and execution time of the forward propagation; instruct, in the forward propagation of the model based on the information of the layer, the GPU to offload the third intermediate data.

In an embodiment, the processor is further configured to: derive the information of the layer based on a total amount of remaining intermediate data being less than or equal to the memory capacity of the GPU and a total offloading time being less than or equal to the execution time of the forward propagation, wherein the total amount of the remaining intermediate data is based on an amount of fourth intermediate data of layers of the plurality of layers of the model other than the layer for which the third intermediate data is offloaded into the NAND, and wherein the total offloading time is based on offloading time of the layer for which the third intermediate data is offloaded into the NAND.

In an embodiment, the first intermediate data comprises activation values, and the computation for the current layer comprises gradient computation with respect to the activation values.

According to an aspect of the disclosure, a storage apparatus comprising a dynamic random access memory (DRAM) and NAND is provided, the storage apparatus is configured to: receive a notification for performing a data prefetching operation from a host, and prefetching intermediate data of a layer of a model to be computed from the NAND into the DRAM based on the received notification.

In an embodiment, the storage apparatus is further configured to: transmit intermediate data of a current layer of the model into a memory of a graphics processing unit (GPU), wherein the current layer of the model is a layer of the model for which computation is being performed, wherein the intermediate data of the current layer is stored in the DRAM, and wherein the intermediate data of the current layer is used by the GPU in backward propagation of the model to perform the computation for the current layer.

In an embodiment, the prefetching of the intermediate data of the layer and the computation for the current layer are performed at least partially in parallel.

In an embodiment, wherein the intermediate data of the layer of the model to be computed is a first intermediate data of the layer, and the storage apparatus is further configured to: receive, in forward propagation of the model, the second intermediate data of the layer, the second intermediate data of the layer being generated by the computation for the layer of the model offloaded from the memory of the GPU to be stored into the NAND.

In an embodiment, the storage apparatus is further configured to: transmit, based on a compute express link (CXL) protocol, the intermediate data of the current layer stored in the DRAM to the memory of the GPU, receive, based on the CXL protocol, the second intermediate data of the layer that is generated by the computation offloaded from the memory of the GPU to be stored into the NAND.

In an embodiment, the storage apparatus comprises a memory-semantics solid state drive (MS SSD).

According to an aspect of the disclosure, a system to which a storage apparatus is applied is provided, the system comprises: a main processor; a memory; and the storage apparatus; wherein the storage apparatus is configured to perform the method for model training.

According to an aspect of the disclosure, a host storage system is provided, the host storage system comprises: a host; and a storage apparatus, wherein the storage apparatus is configured to perform the method for model training.

According to an aspect of the disclosure, a data center system is provided the data center system comprises: a plurality of application servers; and a plurality of storage servers, wherein each storage server comprises a storage apparatus, wherein the storage apparatus is configured to perform the method for model training.

According to an aspect of the disclosure, a computer readable storage medium having a computer program stored thereon is provided, wherein the method for model training is implemented when the computer program is executed by a processor.

The technical solutions provided according to embodiments of the present disclosure bring at least the following beneficial effects: the “memory wall” problem of the GPU is solved by using the data offloading between the GPU and the storage apparatus, and the model training is accelerated by using the data prefetching, which achieves better training throughput; less CPU resources and main memory bandwidth are used and robust performance is provided because the GPU and the storage apparatus transfer data through the direct communication; and higher storage capacity and lower cost for large model training are provided with less complexity in software implementation.

It should be understood that the above general description and the later detailed description are exemplary and explanatory only and do not limit the present disclosure.

### BRIEF DESCRIPTION OF DRAWINGS

The accompanying drawings herein are incorporated into and form part of the specification, illustrate embodiments consistent with the present disclosure, which are used in conjunction with the specification to explain the principles of the present disclosure and do not constitute an undue limitation of the present disclosure.

FIG. 1 illustrates a schematic diagram of a Deep Neural Network (DNN) training iteration and a data reuse pattern.

FIG. 2 illustrates a graph of a growing trend of the number of parameters of a State-of-the-Art (SOTA) model.

FIG. 3 illustrates a schematic diagram of a distributed Graphics Processing Unit (GPU) server training system.

FIG. 4 illustrates a diagram of a system for offloading tensors to Central Processing Unit (CPU) main memory.

FIG. 5 illustrates a diagram of a system for offloading tensors to an SSD.

FIG. 6 illustrates a diagram of a system for model training according to an embodiment of the present disclosure.

FIG. 7 illustrates a diagram of Memory-Semantics Solid State Drive (MS SSD) internal prefetching and interacting with a host according to example embodiments.

FIG. 8 illustrates a flowchart of a process for model training applied to a host according to an embodiment of the present disclosure.

FIG. 9 illustrates a diagram comparing Non-Volatile Memory express (NVMe) as backup storage and MS SSD as backup storage according to an embodiment of the present disclosure.

FIG. 10 illustrates a flowchart of a data prefetching process from MS SSD NAND to DRAM in backward propagation according to an embodiment of the present disclosure.

FIG. 11 illustrates a diagram of a process for prefetching offloaded intermediate data in backward propagation according to an embodiment of the present disclosure.

FIG. 12 illustrates a diagram of an offloading process using MS SSD as backup storage according to an embodiment of the present disclosure.

FIG. 13 illustrates a flow for a process of deriving an optimal offload schedule according to an embodiment of the present disclosure.

FIG. 14 illustrates a flowchart of a process for model training applied to a storage apparatus according to an embodiment of the present disclosure.

FIG. 15 illustrates a diagram of a host according to an embodiment of the present disclosure.

FIG. 16 illustrates a diagram of a storage apparatus according to an embodiment of the present disclosure.

FIG. 17 is a diagram of a system in which a storage device is use, according to an embodiment of the present disclosure.

FIG. 18 is a block diagram of a host storage system according to an embodiment of the present disclosure.

FIG. 19 is a diagram of a data center in which a memory device is used, according to an embodiment of the present disclosure.

### DETAILED DESCRIPTION

In order to enable a person of ordinary skill in the art to better understand the technical solutions of the present disclosure, the technical solutions provide by embodiments of the present disclosure will be clearly and completely described below in conjunction with the accompanying drawings.

It should be noted that the terms “first”, “second”, etc. in the specification and claims of the present disclosure and the accompanying drawings above are used to distinguish similar objects rather than to describe a particular order or sequence. It should be understood that data so distinguished may be interchanged, where appropriate, so that embodiments of the present disclosure described herein may be implemented in an order other than those illustrated or described herein. Embodiments described in the following examples do not represent all embodiments that are consistent with the present disclosure. Rather, they are only examples of devices and methods that are consistent with some aspects of the present disclosure, as detailed in the appended claims.

It should be noted herein that “at least one of the several items” in this disclosure includes “any one of the several items”, “any combination of the several items” and “all of the several items” the juxtaposition of these three categories. For example, “including at least one of A and B” includes the following three juxtapositions: (1) including A; (2) including B; (3) including A and B. Another example is “performing at least one of operation one and operation two”, which means the following three juxtapositions (1) performing operation one; (2) performing operation two; (3) performing operation one and operation two.

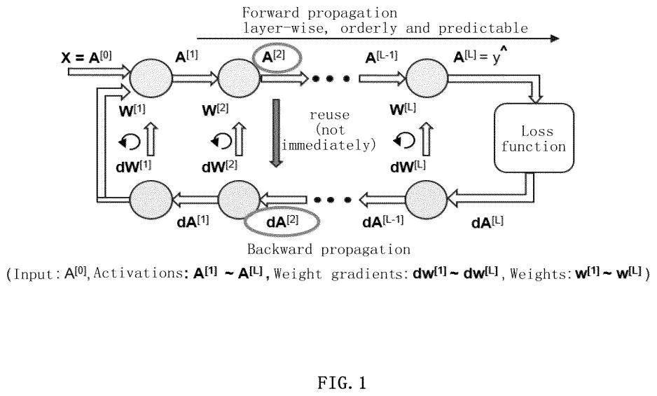

An artificial intelligence model, for example, a deep neural network (DNN) model, consists of many interconnected layers in which samples are propagated. FIG. 1 illustrates a schematic diagram of a DNN training iteration and a data reuse pattern. As shown in FIG. 1, one iteration of computational propagation of the model consists of two processes: forward propagation and backward propagation. The forward propagation computes final output of the model based on inputs and intermediate generated activations. The backward propagation computes gradients according to activation values and loss values. When all layers have completed the computation, weights of each layer are updated based on weight gradients to reduce the error rate of the model output. Referring to FIG. 1, intermediate data (e.g., activation A [2]) generated by the computation for the layer of the model in the forward propagation may be stored and the stored intermediate data is utilized for the computation (i.e., reuse) in backward propagation, for example, the computation of dA^{[2]}.

In the following example embodiments, the intermediate data (or the intermediate results) is illustrated taking an activation (which may also be referred to as an activation tensor, an activation value) as an example, and the computation performed for current layer using the intermediate data in the backward propagation is illustrated taking gradient computation as an example. However it should be understood that the present disclosure is not limited thereto. For example, the intermediate data may also be other data generated by the computation for the layer of the model in the forward propagation, and the computation performed for current layer using the intermediate data in the backward propagation may be any computation related to the intermediate data.

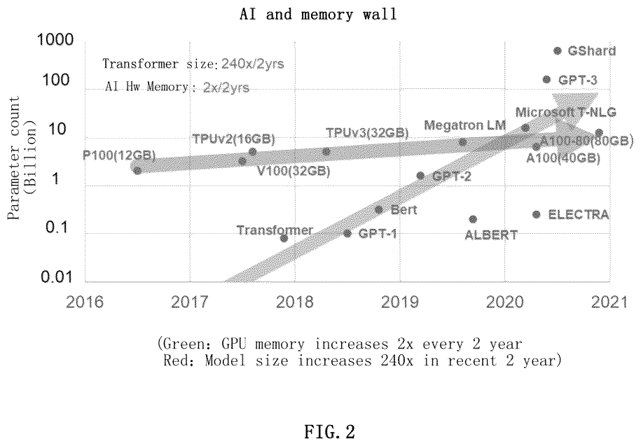

FIG. 2 illustrates a graph illustrating growing trend of the number of parameters of a state of the art (SOTA) model. Large Transformer model has parameters that increase at a near-exponential rate of 240 times every two years. However, the memory of a single GPU only doubles every two years, and the growth of GPU memory is unable to meet the ever-increasing memory demand for AI model training. In order to obtain the large model with higher model accuracy and faster network convergence speed, the training requires deeper network depth and larger training samples, but the GPU are unable to meet the memory demand of this trend, which is often referred to as the “memory wall” problem.

Related art attempts to resolve the “memory wall” problem in the following ways:

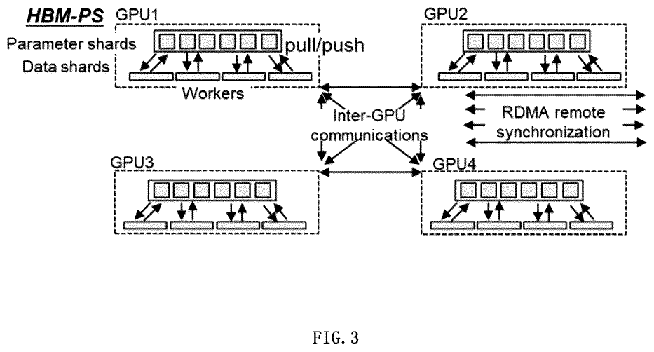

(1) Distributed GPU servers are used for training. FIG. 3 illustrates a diagram of a distributed GPU server training system. As shown in FIG. 3, multiple GPUs are used as parameter servers (PS) to expand the memory, and a series of parallel methods (such as, data parallelism, model parallelism, pipeline parallelism, etc.) are used to accelerate the training.

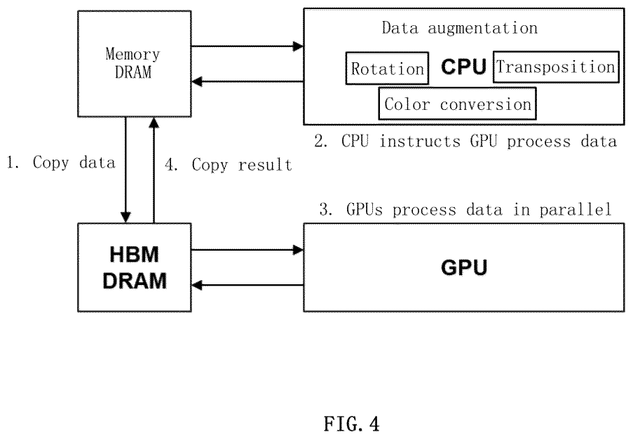

(2) Training model states or activations are offloaded to a memory of CPU (CPU memory). FIG. 4 illustrates a diagram of a system for offloading tensors to CPU main memory. As shown in FIG. 4, the offloading includes buffering a part of the tensors (i.e., the states or activations of the model) from a memory of a GPU (GPU memory) to a CPU memory to avoid GPU memory overflow.

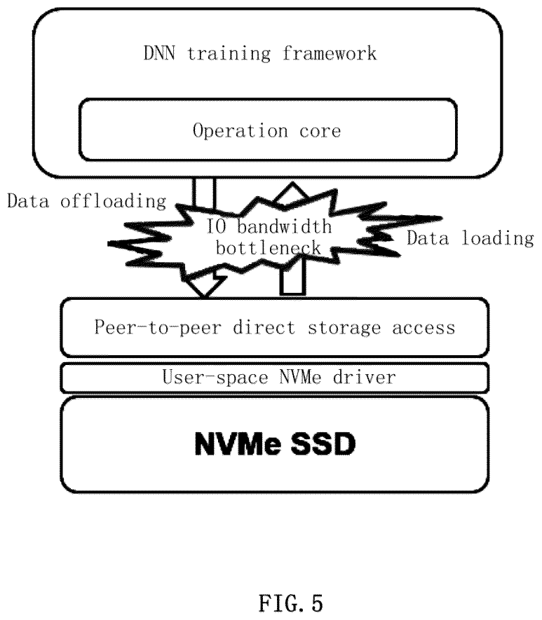

3) Activations are offloaded to non-volatile memory express solid state drive (NVMe SSD). FIG. 5 illustrates a diagram of offloading tensors to an SSD. As shown in FIG. 5, the conventional solid state drive (SSD) is used as backup storage to buffer a part of the activations in the GPU memory. Direct data transfer between GPU and SSD through the manner of peer-to-peer direct storage access may reduce CPU resources and main memory usage.

However, there are several issues with each attempt. For training with the distributed GPU servers, except for high GPU bandwidth, it is not a good choice for storage capacity, training cost, and an offload scheme. For the offloading of training model states or activations to CPU memory, except for simplicity of the offload scheme, it is not a good choice for the training cost, the storage capacity, and robustness as training performance. Finally, for offloading of activations to the NVMe SSD, although the total cost of ownership (TCO) is small, the IO bandwidth of the traditional SSD is the bottleneck. The advantages and disadvantages of the above three solutions are shown in Table 1 below:

TABLE 1

| | | Offloading | |
|---|---|---|---|
| | | intermediate data | |
| | | to CPU memory | Offloading |
| | GPU | (when CPU is | intermediate data to |
| Advantage | servers | occupied) | NVMe SSD |
| Big storage capacity | x | x | ✓ |
| High performance | ✓ | x | x |
| (storage/IO | | | |
| bandwidth/training | | | |
| throughout) | | | |
| Low cost | x | x | ✓ |
| Low software | x | ✓ | ✓ |
| complexity | | | |

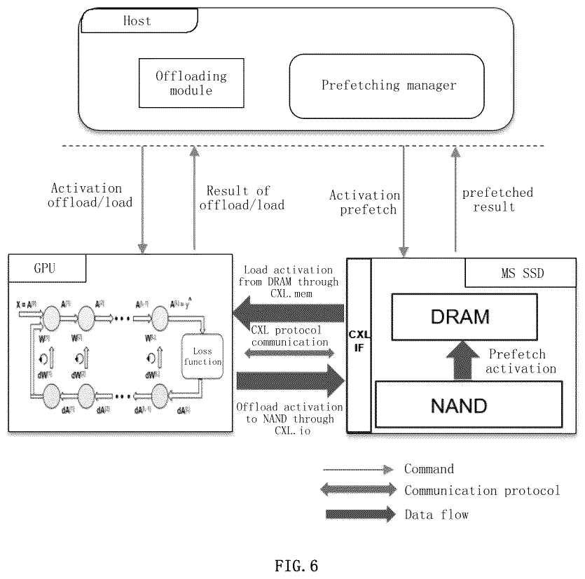

To address the “memory wall” problem of the GPU and overcome the drawbacks of the above solutions, the present disclosure proposes a method for model training which offloads the intermediate data (e.g., the activations) generated during training of a model (e.g., DNN) to a storage apparatus (e.g., a memory-semantics solid state drive (MS SSD)) and accelerates the large model training through a prefetching algorithm for faster loading of the intermediate data. The method for model training, the host, and the storage apparatus according to the present disclosure are specifically described below with reference to FIGS. 6 to 19 of the accompanying drawings.

The model herein may be the deep neural network (DNN) model, but may also be other models including multiple layers, for example, a convolutional neural network (CNN) model, a recurrent neural network (RNN) model, a generative adversarial network (GAN) model, a long-short-term memory network (LSTM) model, a residual network (ResNet, e.g., ResNet-1922) model, an attention mechanism model, a transformer model, a GPT model, a visual geometry group (VGG) model, an OverFeat model, a dense network (DenseNet, e.g., DenseNet-1001), GoogLeNet, and AlexNet, the present disclosure is not limited to thereto, the model may also be other types of artificial intelligence models.

FIG. 6 illustrates a schematic diagram of a system for model training according to example embodiments. Referring to FIG. 6, the system for model training may include a host, a GPU, and a storage apparatus. The host may include an offloading module and a prefetching manager, the storage apparatus may include a dynamic random access memory (DRAM) and a flash NAND, and the training of the model is performed in the GPU. The storage apparatus may be a memory-semantics solid state drive (MS SSD).

In the following example embodiments, the storage apparatus is illustrated using an MS SSD as an example, however, it should be understood that the present disclosure is not limited thereto, for example, the storage apparatus may also be any storage apparatus which provides a hardware cache (e.g., DRAM).

The present disclosure may adopt the following approaches to avoid performance loss due to data transfer between the GPU and the MS SSD achieving better training throughput. In an embodiment, prior to the model training, the offloading module may be used to analyze the entire training process to derive an optimal offload schedule. The analyzing time is negligible compared to the training time of a large model. In a same or another embodiment, when the offloading is about to be completed, the prefetching manager may organize the data prefetching from MS SSD NAND to MS SSD DRAM. FIG. 6 illustrates the interaction among the host, the GPU, and the MS SSD in one iteration of the model. It should be understood that the training of the model may include multiple iterations, each of which may include forward propagation and backward propagation. As shown in FIG. 6, the host may transmit an activation offload/load instruction to the GPU, the GPU communicates with the MS SSD via the compute express link (CXL) protocol, the activations are loaded into the GPU memory from the DRAM of the MS SSD through CXL.mem in the backward propagation, and the activations are offloaded into the NAND of the MS SSD from the GPU memory through CXL.io in the forward propagation. After the offloading/loading is completed, the GPU returns the offload/load results to the host. In addition, in the backward propagation, the host may transmit a notification of activation prefetch to the MS SSD, and the MS SSD receiving the notification may perform the activation prefetch from the NAND to the DRAM and return the result of the prefetch to the host.

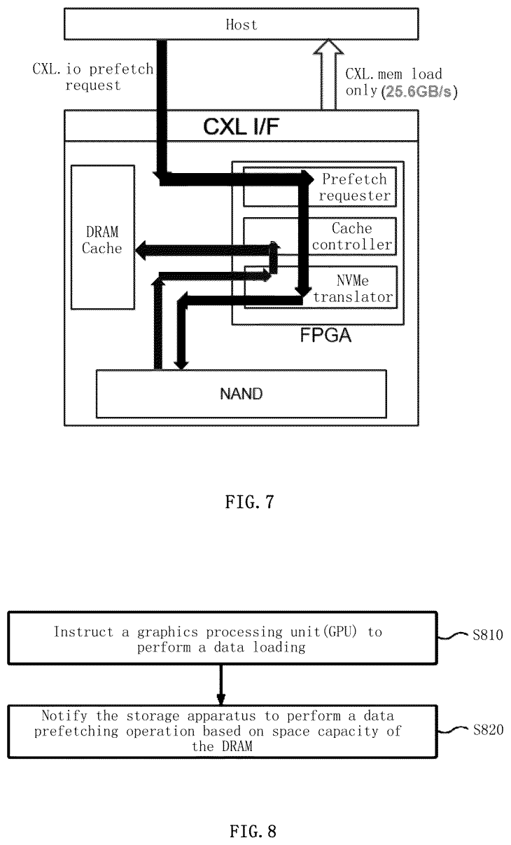

FIG. 7 illustrates a diagram of MS SSD internal prefetching and interacting with a host according to an embodiment.

In FIG. 7, the host communicates with the MS SSD via the CXL protocol. The CXL protocol is an interconnect protocol built on the Peripheral Component Interconnect express (PCIe) that integrates a CPU, an accelerator, and a memory apparatus into a single compute domain. The CXL protocol also allows the host CPU to directly operate the device memory via load/store instructions. The high performance mode of the MS SSD includes the following functions: (1) the data prefetching operation (hardware caching): prefetching is the preloading of data from the NAND to the DRAM according to a host request; and (2) the support for the dual-mode access: NVMe read/write is performed via the CXL.io and logical block address (LBA) memory read is accessed via the CXL.mem, with a read latency of microseconds (DRAM-like read latency: <1 us with 100% cache hit). Table 2 illustrates the CXL.mem performance of the MS SSD as follows:

TABLE 2

| | | | |
|---|---|---|---|
| CXL.mem | Random prefetching | Cache hit 0% | 0.8 MIOPS |
| read | (128)* | Cache hit 50% | 1.5 MIOPS |
| | | Cache hit 100% | 35.0 MIOPS |
| | Latency | Cache hit/miss | <1 us/70 us |

As seen in FIG. 7, the host transmits a prefetch request to the MS SSD via the CXL.io, the MS SSD prefetches data from the NAND to the DRAM cache, and the data stored in the DRAM cache is loaded into the host memory via the CXL.mem.

FIG. 8 illustrates a flowchart of a process for model training applied to a host according to example embodiments.

The training of the model includes two processes: forward propagation and backward propagation. The present disclosure addresses the “memory wall” problem of the GPU and accelerates the training of the large model, by a process in which the intermediate data (e.g., the activations) generated by computation for a layer of the model is offloaded to NAND of a storage apparatus in the forward propagation, and the intermediate data of the layer to be computed is prefetched from the NAND to the DRAM and the intermediate data prefetched to the DRAM is loaded into the GPU memory for computation during the computation of the current layer, in the backward propagation.

First, the data prefetching in the backward propagation is described, in the backward propagation, the intermediate data has been offloaded from the GPU memory to the NAND of the storage apparatus in the forward propagation.

In step S810, a graphics processor (GPU) is instructed to perform a data loading. The data loading loads intermediate data of a current layer of a model for which computation is being performed from a dynamic random access memory (DRAM) of a storage apparatus into a memory of the GPU.

In example embodiments, in the backward propagation, the intermediate data of the current layer of the model for which the computation is being performed has been prefetched from the storage apparatus NAND to the DRAM and is stored in the DRAM. For the computation of the current layer, the host may instruct the GPU to perform the data loading, the GPU receiving the instruction may load the intermediate data of the current layer of the model from the DRAM of the storage apparatus into the GPU memory, and the intermediate data of the current layer may be used by the GPU in the backward propagation of the model to perform the computation for the current layer.

According to example embodiments, the intermediate data may include activation values, and the computation for the current layer may include gradient computation with respect to the activation value.

In step S820, based on the spatial capacity of the DRAM, the storage apparatus is notified to perform a data prefetching operation. The data prefetching operation includes prefetching the intermediate data of a layer of the model to be computed from NAND of the storage apparatus into the DRAM.

According to example embodiments, the data prefetching operation and the computation for the current layer may be performed at least partially in parallel.

In example embodiments, while the GPU performs the computation for the current layer, the host may notify the storage apparatus to perform the data prefetching operation based on the space capacity of the DRAM, that is, the data prefetching operation and the computation for the current layer may be performed at least partially in parallel. The storage apparatus receiving the notification performs the data prefetching operation of prefetching the intermediate data of the layer of the model to be computed from the NAND of the storage apparatus into the DRAM. In the backward propagation, the layer to be computed is a previous layer to the current layer.

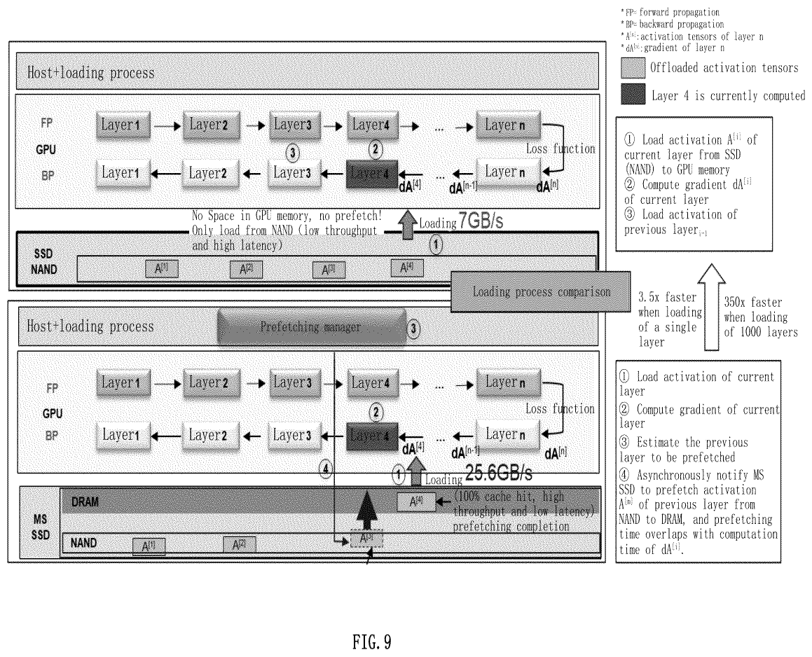

FIG. 9 illustrates a diagram comparing NVMe as backup storage with MS SSD as backup storage according to an embodiment.

Referring to FIG. 9, in the forward propagation, the intermediate data (e.g., activations A^{[1]}-A^{[n]}) generated by the computation for the layer of the model is offloaded into the NAND of the conventional SSD or the MS SSD. And the current layer in which the computation is being performed in the backward propagation is layer 4.

In the conventional SSD as a backup storage, in the backward propagation, three steps are involved: (1) loading the intermediate data of the current layer (e.g., the activation A^{[i]}) from the SSD NAND to the GPU memory; (2) performing the computation for the current layer by the GPU using the intermediate data of the current layer, for example, computation of the gradient of the current layer, dA^{[i]}; and (3) loading the intermediate data of the previous layerᵢ₋₁ (e.g. the activation A^{[i-1]}). At this time, there is no GPU memory space and thus no prefetching, and loading is performed only from the NAND, with low throughput and high latency for the data loading.

In the MS SSD as backup storage according to example embodiments, in the backward propagation, the following four steps are involved: (1) loading the intermediate data (e.g., the activation A^{[i]}) of the current layer from the MS SSD DRAM to the GPU memory; (2) performing the computation for the current layer by the GPU using the intermediate data of the current layer, for example, computation of the gradient of the current layer, dA^{[i]}; and (3) the host (e.g., the prefetching manager of the host) estimates the previous layer to be prefetched (i.e., the layers to be computed), which may include identifying the current layer by the host, and determines whether the previous layer to be prefetched satisfies the prefetching conditions; (4) the host may asynchronously notify the MS SSD to prefetch the intermediate data (e.g., the activation A^{[m]}, m<i) of the previous layer from the NAND into the DRAM, and the MS SSD receiving the notification performs the prefetching operation and the prefetching time overlaps with that of the computation (e.g., the gradient computation) for the current layer. When the intermediate data for the current layer is loaded from the MS SSD into the GPU memory, its data prefetching is already completed in advance and it is stored in the DRAM, and the loading of the intermediate data corresponds to 100% cache hit with high throughput and low latency. In the MS SSD as backup storage according to example embodiments, the loading speed per layer is 3.5 times faster than when the conventional SSD is used as backup storage.

According to example embodiments, the notifying of the storage apparatus to perform the data prefetching operation based on the space capacity of the DRAM includes: traversing the layer of the model to be computed as a prefetch layer, notifying the storage apparatus to perform the data prefetching operation for the prefetch layer based on the DRAM having remaining space and the data prefetching operation having not been performed for the prefetch layer.

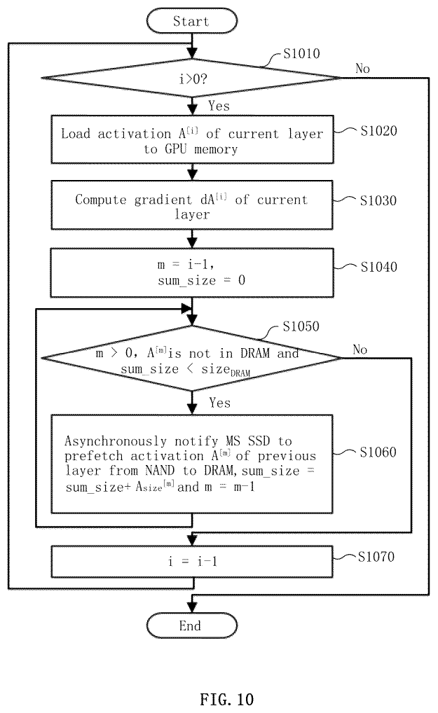

FIG. 10 illustrates a process for data prefetching from MS SSD NAND to DRAM in backward propagation according to example embodiments.

In operation S1010, it is determined whether the current layer i is greater than 0. In the case of “no”, the last layer of the model has been traversed, the flow ends. In the case of “yes”, it proceeds to operation S1020.

In operation S1020, the intermediate data (e.g., activation A^{[i]}) of the current layer is loaded into the GPU memory. The host instructs the GPU to perform the data loading, and the GPU receiving the instruction loads the intermediate data from the DRAM of the storage apparatus (e.g., the MS SSD) into the GPU memory, for example, the GPU may read the intermediate data stored in the DRAM of the storage apparatus into the GPU memory based on CXL.mem. Specifically, the GPU may transmit a read request to the storage apparatus, and then the storage apparatus, in response to the read request, transmits the intermediate data of the current layer stored in the DRAM to be loaded into the GPU memory.

In operation S1030, the gradient of the current layer is computed. The GPU performs the computation for the current layer using the intermediate data of the current layer, such as computation of dA^{[i]}.

In operation S1040, the loop parameters are initialized, m=i−1 and sum_size=0, wherein m denotes the prefetch layer and sum_size denotes the total size of the intermediate data (e.g., the activations) for prefetching. The host traverses the layer of the model to be computed as the prefetch layer to perform the data prefetching operation for the prefetch layer.

In operation S1050, it is determined whether the prefetch layer satisfies the prefetching conditions m>0, A^{[m]} is not in the DRAM (i.e., the data prefetching operation has not been performed for this prefetch layer) and sum_size<size_{DRAM} (i.e., there is space remaining in the DRAM), where size_{DRAM} indicates the size of the DRAM of the storage apparatus (e.g., the MS SSD). The host performs the determination on whether the prefetch layer satisfies the prefetching conditions, in the case of “no”, the data prefetching operation is not performed for the prefetch layer, and it proceeds to operation S1070, and in the case of “yes”, it proceeds to operation S1060.

In operation S1060, the storage apparatus is asynchronously notified to prefetch the intermediate data (e.g., the activation A^{[m]}) of the previous layer (i.e., the m-layer, the prefetch layer) from the NAND to the DRAM, with sum_size=sum_size+A_{size}^{[m]} and m=m−1. The host notifies the MS SSD to perform the data prefetching operation and it returns to operation S1050, and the MS SSD receiving the notification performs the data prefetching operation. The cyclic execution of operation S1050 and operation S1060 may prefetch the intermediate data of a plurality of previous layers (i.e., layers to be computed) during one time of computation for the current layer of the model.

At operation S1070, the current layer is updated by i=i−1, and it returns to operation S1010.

The operations of the above flow involve operations of the host, the GPU, and the storage apparatus, and the operations are not limited to the sequential execution, but may also be performed concurrently, for example, operation S1040 may be performed concurrently with operation S1050 and operation S1060.

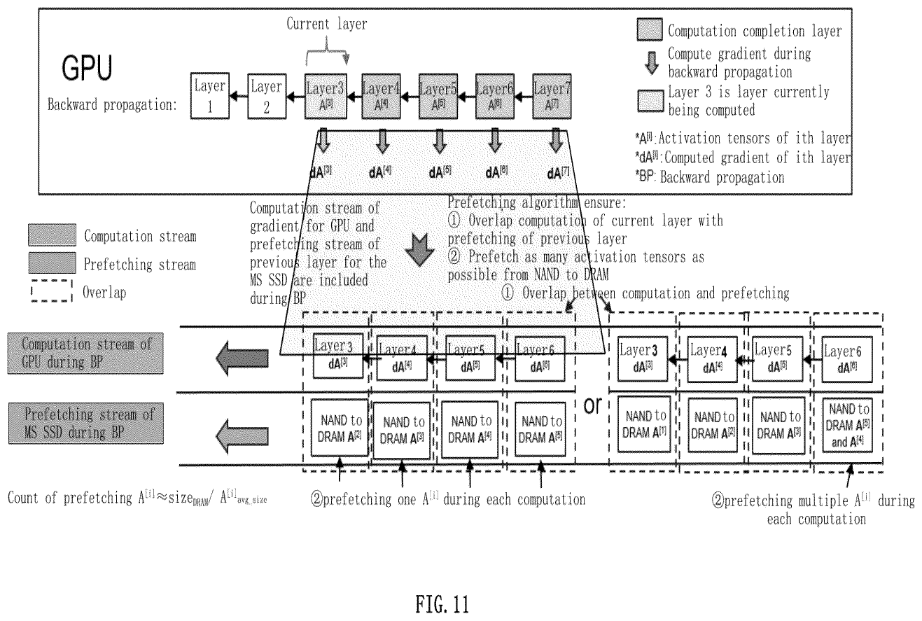

FIG. 11 illustrates a diagram of a process for prefetching offloaded intermediate data in backward propagation according to example embodiments.

The GPU in the backward propagation uses the intermediate data (e.g., activations) of the current layer to perform the computation (e.g., computation of gradients) for the current layer. Referring to FIG. 11, the current layer in the GPU for which the computation is being performed is layer 3, layers 1-2 are previous layers or layers to be computed, and layers 4-7 are layers for which the computation is completed. During the backward propagation, a computation stream of gradient for the GPU and a prefetching stream of the previous layer for the MS SSD are included. The prefetching algorithm may cause the computation of the current layer to overlap with the prefetching of the previous layers, and prefetching as many activations as possible from the NAND into the DRAM, a count of prefetching A^{[i]}≈size_{DRAM}/A^{[i]}_{avg_size}. In example embodiments, one A^{[i]} may be prefetched during one time of computation for the layer of the model, for example, in the computation for layers 6, 5, 4, and 3, corresponding A^{[5]}, A^{[4]}, A^{[3]} and A^{[2]} are prefetched sequentially; or multiple A^{[i]} may be prefetched during one time of computation for the layer of the model, for example, in the computation for layers 6, 5, 4, and 3, corresponding A^{[5]} and A^{[4]}, A^{[3]}, A^{[2]}, and A^{[1]} are prefetched sequentially, wherein, in the computation for layer 6, two activations of A^{[5]} and A^{[4]} are prefetched from the NAND into the DRAM.

Next, data offloading in the forward propagation is described, and the intermediate data loaded in the backward propagation are all the intermediate data offloaded in the forward propagation.

According to example embodiments, in the forward propagation of the model, the GPU may be instructed to perform the data offloading, where the data offloading offloads the intermediate data generated by the computation for the layer of the model from the memory of the GPU to the NAND.

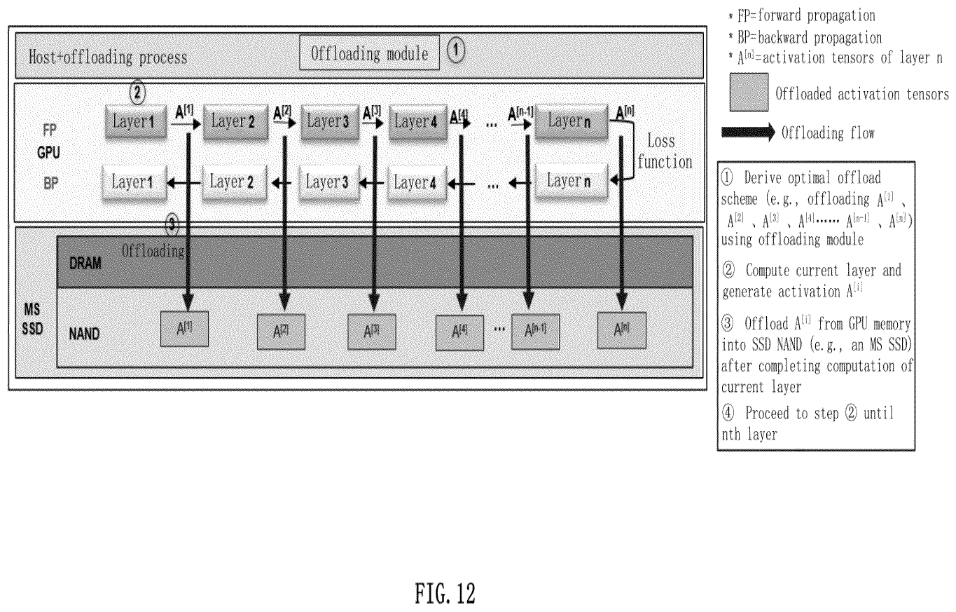

FIG. 12 illustrates a diagram of an offloading process using MS SSD as backup storage according to example embodiments.

Referring to FIG. 12, in the forward propagation, the offloading process may include four steps: (1) deriving an optimal offload scheme (e.g., offloading A^{[1]}, A^{[2]}, A^{[3]}, A^{[4]} A^{[n-1]}, A^{[n]}) by the host using the offloading module; and (2) computing the current layer and generating the intermediate data (e.g., the activation A^{[i]}) by the GPU; (3) offloading the intermediate data from the GPU memory into the NAND of the storage apparatus (e.g., an MS SSD) after completing the computation of the current layer, where the host may instruct the GPU to perform the data offloading. The GPU receiving the instruction from the host offloads the intermediate data from the GPU memory into the NAND of the storage apparatus. Accordingly, the storage apparatus receives the intermediate data offloaded from the GPU memory to store it into the NAND, where the data offloading between the GPU and the storage apparatus may be based on CXL.io; and (4) proceeding to step (2) until the nth layer of the model.

According to example embodiments, prior to the model training, information of the layer for which the intermediate data is offloaded into the NAND among a plurality of layers of the model may be obtained based on memory capacity of the GPU and execution time of the forward propagation. The instructing of the GPU to perform the data offloading in the forward propagation of the model may include instructing, in the forward propagation of the model based on the information of the layer, the GPU to perform the data offloading.

According to example embodiments, the information of the layer may be derived based on a total amount of remaining intermediate data being less than or equal to the memory capacity of the GPU and total offloading time being less than or equal to the execution time of the forward propagation. The total amount of the remaining intermediate data is based on an amount of the intermediate data of layers of the plurality of the layers of the model other than the layer for which the intermediate data is offloaded into the NAND. The total offloading time is based on offloading time of the layer for which the intermediate data is offloaded into the NAND.

In example embodiment, the offloading of intermediate data may be performed on the basis that the sum of the intermediate data (e.g., the activation) generated by the computation for each layer of the model and the total size of other memory is greater than or equal to the memory capacity of the GPU, that is, the following Equation 1 needs to be satisfied to ensure trainability:

$$A {1}_{size} + A {2}_{size} + … + {An}_{size} + Non - {offload}_{s i z e} >= {GPU}_{s i z e} \qquad Equation 1$$

where An_{size} represents the size of the nth offloaded activation tensor, GPU_{size} represents the memory capacity of the GPU, and Non-offload_{size} represents the total size of other memory (i.e., resident objects, e.g., inputs, temporary workspace, etc.).

In addition, the information of the layer for which the intermediate data is offloaded to the NAND among the plurality of layers of the model, i.e., the offload scheme or the offload schedule, is derived based on the satisfaction of Equation 2 below:

$$A {1}_{time} + A {2}_{time} + … + {An}_{time} <= {FP}_{time} \qquad Equation 2$$

Where Anₜᵢₘₑ represents the offloading time of the nth activation tensor, FPtime represents the execution time of the forward propagation (excluding the offloading time).

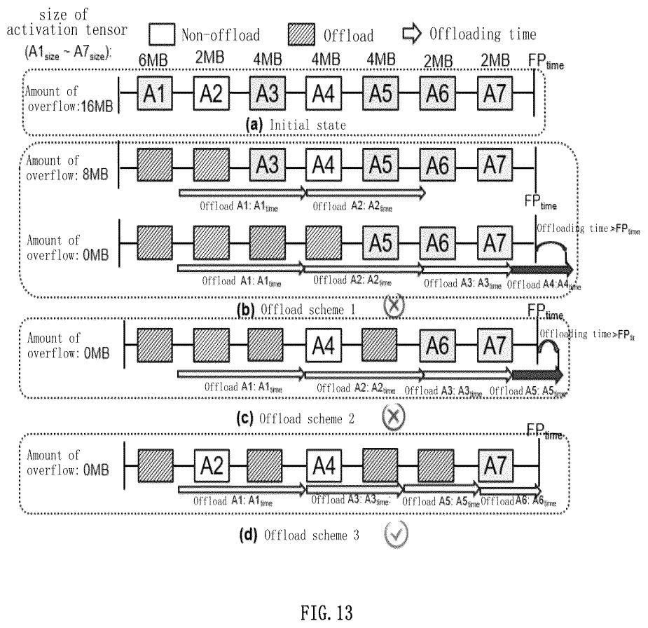

FIG. 13 illustrates a flow for deriving an optimal offload schedule according to example embodiments. In FIG. 13, an initial state and three offload schemes, namely offload scenarios 1-3, respectively, are illustrated.

Initial state: the size of GPU memory capacity: GPU_{size}=8 MB, A1˜A7 represent the activation tensors of layer₍₁₎˜layer₍₇₎, and A1_{size}˜A7_{size} are sequentially 6 MB, 2 MB, 4 MB, 4 MB, 4 MB, 2 MB, and 2 MB, respectively. The overflow with respect to the GPU memory capacity (an amount of overflow)=A1_{size}+A2_{size}+A3_{size}+A4_{size}+A5_{size}+A6_{size}+A7_{size}−GPU_{size}=16 MB.

Offload scheme 1: the offloading size: A1_{size}+A2_{size}=8 MB, the overflow with respect to the GPU memory capacity after offloading: 8 MB, the offloading time: A1ₜᵢₘₑ+A2ₜᵢₘₑ<FPtime; or the offloading size: A1+A2+A3+A4=16 MB, the overflow with respect to the GPU memory capacity after offloading: OMB, the offloading time: A1ₜᵢₘₑ+A2ₜᵢₘₑ+A3ₜᵢₘₑ+A4ₜᵢₘₑ>FPₜᵢₘₑ.

Offload scheme 2: the offloading size: A1_{size}+A2_{size}+A3_{size}+A5_{size}=16 MB, the overflow with respect to the GPU memory capacity after offloading: OMB, the offloading time: A1ₜᵢₘₑ+A2ₜᵢₘₑ+A3ₜᵢₘₑ+A5ₜᵢₘₑ>FPₜᵢₘₑ.

Offload scheme 3: the offloading size: A1_{size}+A3_{size}+A5_{size}+A6_{size}=16 MB, the overflow with respect to the GPU memory capacity after offloading: OMB, the offloading time: A1ₜᵢₘₑ+A3ₜᵢₘₑ+A5ₜᵢₘₑ+A6ₜᵢₘₑ=FPₜᵢₘₑ.

The offload schemes 1 and 2 in FIG. 13 may not be considered optimal offload schemes, while scheme 3 may be. In offload scheme 3, the total amount of the remaining activation tensor (i.e., the total amount of remaining intermediate data) does not exceed the GPU memory capacity and the offloading time does not exceed the execution time of the forward propagation, In offload scheme 3, the total amount of the remaining activation tensor includes the sum of the amount of the activation tensor of layers of the plurality of layers of the model other than the layers for which the activation tensor is offloaded into the NAND. For example, in offload scheme 3, the total amount of the remaining activation tensor=A2_{size}+A4_{size}+A7_{size}=8 MB=GPU_{size}. The process of selecting the offloading in FIG. 13 is repeated until an optimal offload scheme is derived, or, if an optimal offload scheme does not exist, a suboptimal offload scheme is selected to ensure trainability. For example, the optimal offload scheme may be a scheme in which the total amount of the remaining activation tensor is equal to the GPU memory capacity and the offloading time is equal to the execution time of the forward propagation.

In embodiments of the present disclosure, prior to the model training, the information of the layer for which the intermediate data is offloaded into the NAND among the plurality of layers of the model is derived by the host. When the model is being trained, the information of the layer (e.g., an offload indication) may be indicated to the GPU in the forward propagation of each iteration of the model (one indication per iteration), and the GPU performs offloading of the corresponding layer for that iteration based on the information of the layer. The CPU may also instruct to the GPU to perform offloading of the corresponding layer, after the computation of that layer is finished based on the information of the layer, in the forward propagation of each iteration of the model (multiple indications per iteration), and the GPU performs the offloading of the corresponding layer based on the instruction. In addition, the layer that performs the data offloading in the forward propagation is the layer for which the data prefetching and the data loading operations are performed in the backward propagation.

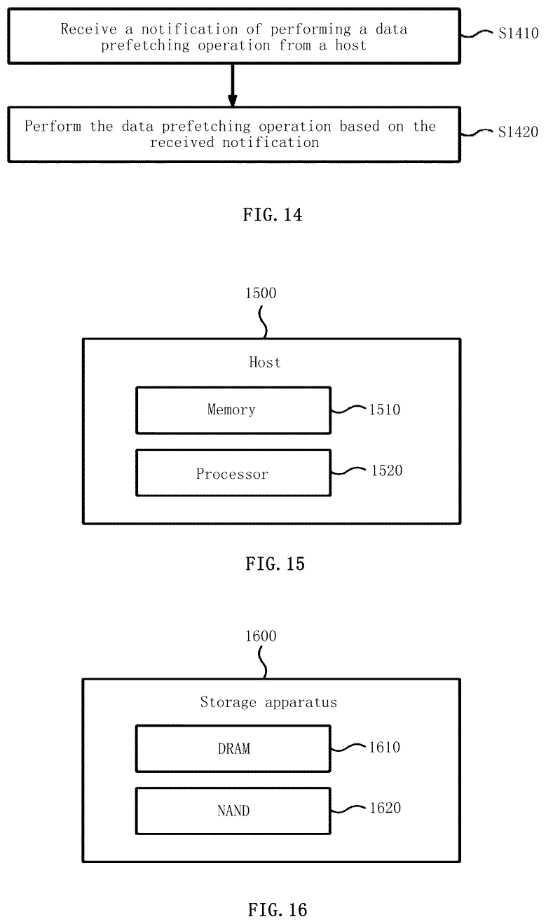

FIG. 14 illustrates a flowchart of a process for model training applied to a storage apparatus according to example embodiments. The storage apparatus may include DRAM and NAND.

In step S1410, a notification of performing a data prefetching operation is received from a host.

In example embodiments, in the backward propagation, the host may asynchronously notify the storage apparatus (e.g., the MS SSD) to prefetch the intermediate data (e.g., the activation A [m], i being the current layer, m<i) of a previous layer (i.e., a layer to be computed) from the NAND to the DRAM.

In step S1420, the data prefetching operation is performed based on the received notification, where the data prefetching operation includes prefetching intermediate data of a layer of a model to be computed from the NAND to the DRAM.

In example embodiments, the storage apparatus (e.g., the MS SSD) receiving the notification performs the prefetching operation of prefetching the intermediate data (e.g., the activation A^{[m]}) of the previous layer from the NAND into the DRAM.

According to example embodiments, the method may further include transmitting the intermediate data of a current layer of the model for which computation is being performed stored in the DRAM to be loaded into a memory of a graphics processing unit (GPU), where the intermediate data of the current layer is used by a GPU in backward propagation of the model to perform the computation for the current layer. Specifically, the intermediate data of the current layer stored in the DRAM is transmitted to be loaded into the graphics processor a memory of the GPU based on a compute express link (CXL) protocol.

According to example embodiments, the data prefetching operation and the computation for the current layer may be performed at least partially in parallel.

In example embodiments, in the backward propagation, the host instructs the GPU to perform the data loading, and the GPU receiving the instruction loads the intermediate data of the current layer (e.g., the activation A^{[i]}, i being the current layer) from the DRAM of the storage apparatus (e.g., the MS SSD) into the GPU memory, for example, the GPU may, based on the CXL.mem, read the intermediate data stored in the DRAM of the storage apparatus into the GPU memory. Specifically, the GPU may transmit a read request to the storage apparatus, then the storage apparatus, in response to the read request, transmits the intermediate data of the current layer stored in the DRAM to be loaded into the GPU memory. Next, the intermediate data of the current layer is used by the GPU in backward propagation of the model to perform the computation for the current layer (e.g., including the gradient computation with respect to the activation, dA^{[i]}).

In example embodiments, in the backward propagation, a computation stream of gradient for the GPU and a prefetching stream of the previous layer for the MS SSD may be included, and the computation of the current layer may be made to overlap with the prefetching of the previous layer.

According to example embodiments, the method may further include receiving, in forward propagation of the model, the intermediate data generated by the computation for the layer of the model offloaded from the memory of the GPU to be stored into the NAND. Specifically, the intermediate data generated by the computation offloaded from the memory of the GPU is received to be stored into the NAND based on the compute express link (CXL) protocol.

In example embodiments, in the forward propagation, the host may instruct the GPU to perform data offloading, the GPU receiving the instruction from the host offloads the intermediate data from the GPU memory into the NAND of the storage apparatus, and accordingly, the storage apparatus receives the intermediate data offloaded from the GPU memory to be stored in the NAND, where the data offloading between the GPU and the storage apparatus may be based on the CXL.io.

The method for model training applied to the host and the storage apparatus as described above use the data offloading between the GPU and the storage apparatus to solve the “memory wall” problem of the GPU and use the data prefetching to accelerate the model training which achieves better training throughput, in which less CPU resources and main memory bandwidth are used and robust performance is provided because the GPU and the storage apparatus transfer data through the direct communication, and higher storage capacity and lower cost for large model training are provided with less complexity in software implementation.

FIG. 15 illustrates a schematic diagram of a host according to example embodiments.

Referring to FIG. 15, the host 1500 may include a memory 1510 and a processor 1520, where the memory 1520 may store instructions. The instructions, when executed by the processor 1520, may cause the processor 1520 to instruct a graphics processing unit (GPU) to perform a data loading which loads intermediate data of a current layer of a model for which computation is being performed from a dynamic random access memory (DRAM) of a storage apparatus into GPU memory, The instructions may case the processor 1520 to notify, based on space capacity of the DRAM, the storage apparatus to perform a data prefetching operation which includes prefetching the intermediate data of a layer of the model to be computed from NAND of the storage apparatus into the DRAM. The intermediate data of the current layer is used by the GPU in backward propagation of the model to perform the computation for the current layer.

According to example embodiments, the data prefetching operation and the computation for the current layer are performed at least partially in parallel.

According to example embodiments, the instructions, when executed by the processor 1520, may cause the processor 1520 to traverse the layer of the model to be computed as a prefetch layer, and notify the storage apparatus to perform the data prefetching operation for the prefetch layer based on the DRAM having remaining space and the data prefetching operation having not been performed for the prefetch layer.

According to example embodiments, the instructions, when executed by the processor 1520, may cause the processor 1520 to instruct, in forward propagation of the model, the GPU to perform data offloading which offloads the intermediate data generated by the computation for the layer of the model from the memory of the GPU into the NAND.

According to example embodiments, the instructions, when executed by the processor 1520, may cause the processor 1520 to obtain, prior to the model training, information of the layer for which the intermediate data is offloaded into the NAND among a plurality of layers of the model based on memory capacity of the GPU and execution time of the forward propagation. The instructions, when executed by the processor 1520, may cause the processor 1520 to control or instruct, in the forward propagation of the model based on the information of the layer, the GPU to perform the data offloading.

According to example embodiments, the instructions, when executed by the processor 1520, may cause the processor 1520 to derive the information of the layer based on a total amount of remaining intermediate data being less than or equal to the memory capacity of the GPU and total offloading time being less than or equal to the execution time of the forward propagation. The total amount of the remaining intermediate data is based on an amount of the intermediate data of layers of the plurality of the layers of the model other than the layer for which the intermediate data is offloaded into the NAND. The total offloading time is based on offloading time of the layer for which the intermediate data is offloaded into the NAND.

According to example embodiments, the intermediate data may include activation values, and the computation for the current layer includes gradient computation with respect to the activation values.

FIG. 16 illustrates a schematic diagram of a storage apparatus according to example embodiments.

Referring to FIG. 16, the storage apparatus 1600 may include a dynamic random access memory DRAM 1610 and NAND 1620, and the storage apparatus 1600 may receive a notification of performing a data prefetching operation from a host, and perform the data prefetching operation based on the received notification, wherein the data prefetching operation includes prefetching intermediate data of a layer of a model to be computed from the NAND 1620 into the DRAM 1610.

According to example embodiments, the storage apparatus 1600 may transmit the intermediate data of a current layer of the model for which computation is being performed stored in the DRAM 1610 to be loaded into a memory of a graphics processing unit (GPU), wherein the intermediate data of the current layer is used by a GPU in backward propagation of the model to perform the computation for the current layer.

According to example embodiments, the data prefetching operation and the computation for the current layer are performed at least partially in parallel.

According to example embodiments, the storage apparatus 1600 may receive, in forward propagation of the model, the intermediate data generated by the computation for the layer of the model offloaded from the memory of the GPU to be stored into the NAND 1620.

According to example embodiments, the storage apparatus 1600 may transmit, based on a CXL protocol, the intermediate data of the current layer stored in the DRAM 1610 to be loaded into the memory of the GPU, and receive, based on the CXL protocol, the intermediate data generated by the computation offloaded from the memory of the GPU to be stored into the NAND 1620.

According to example embodiments, the storage apparatus 1600 may comprise a memory-semantics solid state drive (MS SSD).

The host and storage apparatuses as described above use the data offloading between the GPU and the storage apparatus to solve the “memory wall” problem of the GPU and use the data prefetching to accelerate the model training which achieves better training throughput, in which less CPU resources and main memory bandwidth are used and robust performance is provided because the GPU and the storage apparatus transfer data through the direct communication, and higher storage capacity and lower cost for large model training are provided with less complexity in software implementation.

The advantages and disadvantages of the present disclosure over existing solutions are shown in Table 3 below:

TABLE 3

| | | Offloading | | |
|---|---|---|---|---|
| | | intermediate data | Offloading | |
| | | to CPU memory | intermediate | |
| | GPU | (when CPU is | data to | Present |
| Advantage | servers | occupied)) | NVMe SSD | disclosure |
| Big storage | x | x | ✓ | ✓ |
| capacity | | | | |
| High performance | ✓ | x | x | ✓ |
| (storage/IO | | | | |
| bandwidth/ | | | | |
| training | | | | |
| throughout) | | | | |
| Low cost | x | x | ✓ | ✓ |
| Low software | x | ✓ | ✓ | ✓ |
| complexity | | | | |

The method for model training, the host, and the storage apparatus of the present disclosure, compared to the traditional SSD, higher training throughput is provided based on the MS SSD by efficiently offloading and loading the intermediate data during the training process. Any large model (e.g., DNN) training can use it through a simple software stack implementation. Robust performance is provided due to less CPU resources and memory bandwidth competed with CPU process. In addition, larger storage capacity and lower cost than high bandwidth memory (HBM) DRAM of GPU and CPU DRAM (where HBM DRAM: $20/GB, DDR4 DRAM: $3.6/GB and flash NAND: $0.102/GB) are provided, and training TCO is reduced. In short, the present disclosure provides the larger storage capacity and the lower cost for training the large model. The present disclosure can be used for training a large model where storage capacity and bandwidth are dominant.

For example, training a trillion-parameter model will generate over 1 TB of activation tensors (i.e., intermediate data) when the training batch size is set to only 1. By buffering (i.e., offloading) the 1 TB of activation tensors, when the existing solutions are compared to the present disclosure, the specific effect is shown in Tables 4-5:

TABLE 4

| | Data transfer |
|---|---|
| | latency(s) |
| Offloading activations to NVMe SSD (7 GB/s) | 146 |
| Present disclosure (25.5 GB/s) | 40 |

TABLE 5

| | Storage cost($) |
|---|---|
| Use of distributed GPU servers | 20480 |
| Offloading activations to CPU | 3686.4 |
| memory | |
| Present disclosure | 104.448 |

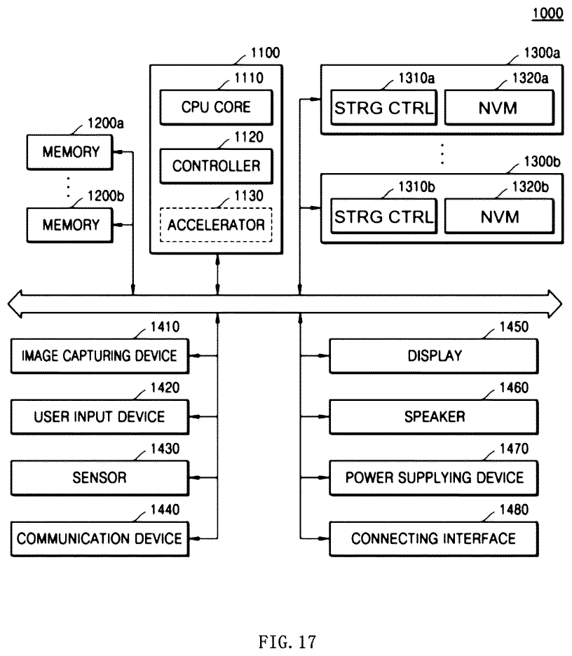

FIG. 17 is a diagram of a system 1000 to which a storage device is applied according to an embodiment.

The system 1000 of FIG. 17 may be, for example, a mobile system, such as a portable communication terminal (e.g., a mobile phone), a smartphone, a tablet personal computer (PC), a wearable device, a healthcare device, or an Internet of Things (IOT) device. However, the system 1000 of FIG. 17 is not limited thereto and may be, for example, a PC, a laptop computer, a server, a media player, or an automotive device (e.g., a navigation device).

Referring to FIG. 17, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000 including, for example, operations of other components included in the system 1000. The main processor 1100 may be implemented as, for example, a general-purpose processor, a dedicated processor, or an application processor.

The main processor 1100 may include at least one CPU core 1110 and a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as, for example, an artificial intelligence (AI) data operation. The accelerator 1130 may include, for example, a graphics processing unit (GPU), a neural processing unit (NPU) and/or a data processing unit (DPU), and may be implemented as a chip that is physically separate from the other components of the main processor 1100.

The memories 1200a and 1200b may be used as main memory devices of the system 1000. Although each of the memories 1200a and 1200b may include a volatile memory, such as, for example, static random access memory (SRAM) and/or dynamic RAM (DRAM), each of the memories 1200a and 1200b may include non-volatile memory according to embodiments, such as, for example, a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and may have a larger storage capacity than the memories 1200a and 1200b. The storage devices 1300a and 1300b may respectively include storage controllers (STRG CTRL) 1310a and 1310b and non-volatile memories (NVM) 1320a and 1320b configured to store data under the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as, for example, PRAM and/or RRAM.

The storage devices 1300a and 1300b may be physically separated from the main processor 1100 and included in the system 1000, or may be implemented in the same package as the main processor 1100. The storage devices 1300a and 1300b may be solid-state devices (SSDs) or memory cards, and be removably combined with other components of the system 100 through an interface, such as the connecting interface 1480 that is described further below. The storage devices 1300a and 1300b may be devices to which a standard protocol, such as, for example, a universal flash storage (UFS), an embedded multi-media card (eMMC), or a non-volatile memory express (NVMe), is applied. However, the storage devices 1300a and 1300b are not limited thereto.

The image capturing device 1410 may capture still images or moving images. The image capturing device 1410 may include, for example, a camera, a camcorder, and/or a webcam.

The user input device 1420 may receive various types of data input by a user of the system 1000 and may include, for example, a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include, for example, a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include, for example, an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery embedded in the system 1000 and/or an external power source, and supply the converted power to each of components of the system 1000.

The connecting interface 1480 may provide a connection between the system 1000 and an external device, which is connected to the system 1000, and is capable of transmitting and receiving data to and from the system 1000. The connecting interface 1480 may be implemented by using various interface schemes, such as, for example, advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

According to the embodiments of the present disclosure, a system (e.g., 1000), to which a storage apparatus is applied, is provided, the system includes a main processor (e.g., 1100); a memory (e.g., 1200a and 1200b); and the storage apparatus (e.g., 1300a and 1300b), wherein the storage apparatus is configured to perform the method for model training as described above.

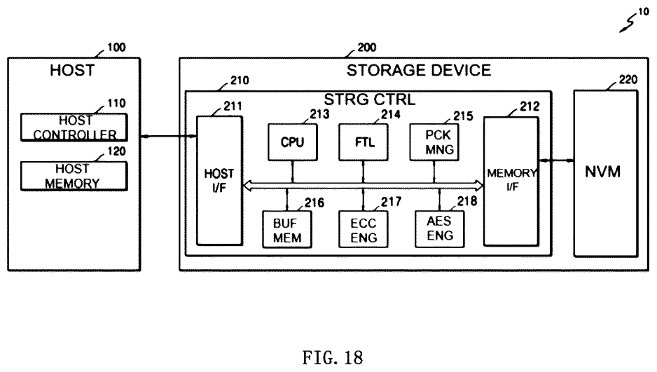

FIG. 18 is a block diagram of a host storage system 10 according to an embodiment.

The host storage system 10 may include a host 100 and a storage device 200. The storage device 200 may include a storage controller 210 (referred to as “STRG CTRL” in FIG. 18) and an NVM 220. According to an embodiment, the host 100 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and may transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to an embodiment, the host controller 110 and the host memory 120 may be implemented as separate semiconductor chips. Alternatively, in some embodiments, the host controller 110 and the host memory 120 may be integrated in the same semiconductor chip. As an example, the host controller 110 may be any one of a plurality of devices included in an application processor (AP). The AP may be implemented as, for example, a system-on-chip (SoC). Further, the host memory 120 may be an embedded memory included in the AP or an NVM or memory device located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, a CPU 213, a flash translation layer (FTL) 214, a packet manager 215 (referred to as “PCK MNG” in FIG. 18), a buffer memory 216, an error correction code (ECC) engine 217, and an advanced encryption standard (AES) engine 218. The storage controller 210 may further include a working memory in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as, for example, Toggle or open NAND flash interface (ONFI).

The FTL 214 may perform various functions, such as, for example, an address mapping operation, a wear-leveling operation, and a garbage collection operation. The address mapping operation may be an operation of converting a logical address received from the host 100 into a physical address used to actually store data in the NVM 220. The wear-leveling operation may be a technique for preventing or reducing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. In addition, the buffer memory 216 may temporarily store data to be written to the NVM 220 or data to be read from the NVM 220. Although the buffer memory 216 may be a component included in the storage controller 210, the buffer memory 216 may be disposed outside of the storage controller 210 in embodiments.

The ECC engine 217 may perform error detection and correction operations on read data read from the NVM 220. For example, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

According to the embodiments of the present disclosure, a host storage system (e.g., 10) is provided, the host storage system includes a host (e.g., 100); and a storage apparatus (200), wherein the storage apparatus is configured to perform the method for model training as described above.

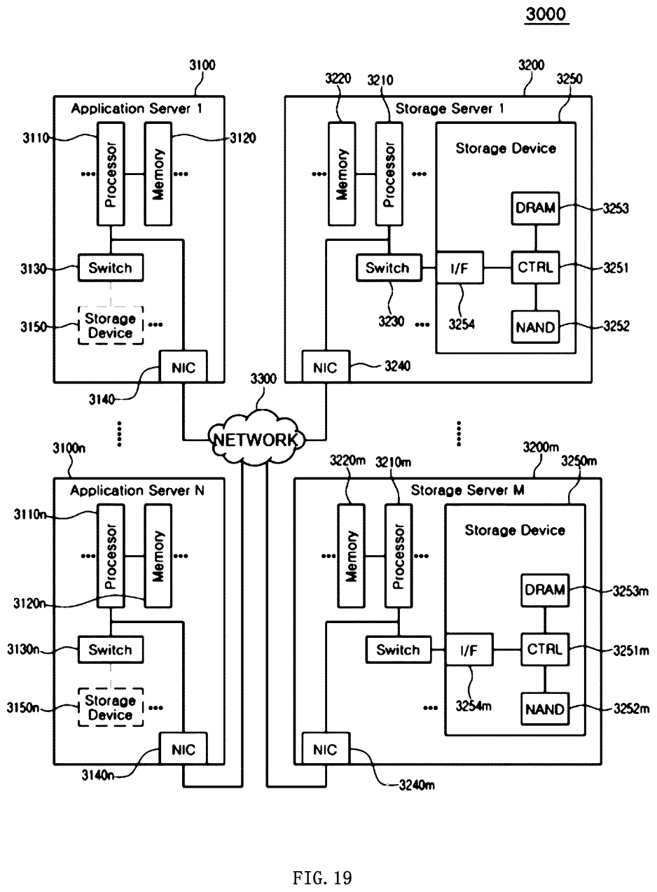

FIG. 19 is a diagram of a data center 3000 to which a memory device is applied, according to an embodiment.

### Application/Storage Server

Referring to FIG. 19, the data center 3000 may be a facility that collects various types of pieces of data and provides services, and may be referred to as a data storage center. The data center 3000 may be a system for operating a search engine and a database, and may be a computing system used by companies, such as banks or government agencies. The data center 3000 may include application servers 3100 to 3100n and storage servers 3200 to 3200m, in which n and m are positive integers. The number of application servers 3100 to 3100n and the number of storage servers 3200 to 3200m may be variously selected according to embodiments. The number of application servers 3100 to 3100n may be different from the number of storage servers 3200 to 3200m.

The application server 3100 or the storage server 3200 may include at least one of processors 3110 and 3210 and memories 3120 and 3220, at least one of switches 3130 to 3130n, at least one of network interface cards (NICs) 3140 to 3140n and 3240 to 3240m, at least one of DRAMs 3253 to 3253m, and at least one of controllers 3251 to 3251m. The storage server 3200 will now be described as an example. The processor 3210 may control all operations of the storage server 3200, access the memory 3220, and execute instructions and/or data loaded in the memory 3220. The memory 3220 may be, for example, a double-data-rate synchronous DRAM (DDR SDRAM), a high-bandwidth memory (HBM), a hybrid memory cube (HMC), a dual in-line memory module (DIMM), Optane™ DIMM, and/or a non-volatile DIMM (NVMDIMM). In some embodiments, the numbers of processors 3210 and memories 3220 included in the storage server 3200 may be variously selected. In an embodiment, the processor 3210 and the memory 3220 may provide a processor-memory pair. In an embodiment, the number of processors 3210 may be different from the number of memories 3220. The processor 3210 may include a single-core processor or a multi-core processor. The above description of the storage server 3200 may be similarly applied to the application server 3100. In some embodiments, the application server 3100 may not include a storage device 3150. The storage server 3200 may include at least one storage device 3250. The number of storage devices 3250 included in the storage server 3200 may be variously selected according to embodiments.

### Network

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and may use an optical switch with high performance and high availability. The storage servers 3200 to 3200m may be provided as file storages, block storages, or object storages according to an access method of the network 3300.

In an embodiment, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In an embodiment, the network 3300 may be a general network, such as a TCP/IP network. For example, the network 3300 may be implemented according to a protocol, such as FC over Ethernet (FCOE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

### Interface Structure/Type

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC 3240. The switch 3230 may selectively connect the processor 3210 to the storage device 3250 or selectively connect the NIC 3240 to the storage device 3250 under the control of the processor 3210.

In an embodiment, the NIC 3240 may include a network interface card and a network adaptor. The NIC 3240 may be connected to the network 3300 by, for example, a wired interface, a wireless interface, a BLUETOOTH interface, or an optical interface. The NIC 3240 may include an internal memory, a digital signal processor (DSP), and a host bus interface and may be connected to the processor 3210 and/or the switch 3230 through the host bus interface. The host bus interface may be implemented as one of the above-described examples of the interface 3254. In an embodiment, the NIC 3240 may be integrated with at least one of the processor 3210, the switch 3230, and the storage device 3250.

### Interface Operation

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

### SSD Operation

The controller 3251 may control all operations of the storage device 3250. In an embodiment, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

According to an exemplary embodiment of the present disclosure, a data center system (e.g., 3000) is provided, the data center system includes a plurality of application servers (3100 to 3100n); and a plurality of storage servers (e.g., 3200 to 3200m), wherein each storage server includes a storage apparatus, wherein the storage apparatus is configured to perform the method for model training as described above.

As is traditional in the field of the disclosure, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

According to embodiments of the present disclosure, there is provided a computer-readable storage medium storing a computer program, wherein the computer program when executed by a processor, implements the method for model training as described above.

According to embodiments of the present disclosure, there is provided an electronic apparatus comprising: a processor, and a memory storing a computer program, wherein the computer program when executed by a processor, implements the method for model training as described above.

According to an exemplary embodiment of the present disclosure, a computer-readable storage medium may also be provided, wherein a computer program is stored thereon, the program when executed may implement the method for model training as described above. Examples of computer-readable storage media include read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, hard disk drive (HDD), solid state drive (SSD), card-based memory (such as, e.g., multimedia cards, Secure Digital (SD) cards and/or Extreme Digital (XD) cards), magnetic tapes, floppy disks, magneto-optical data storage devices, optical data storage devices, hard disks, solid state disks, and/or any other device, where the other device is configured to store the computer programs and any associated data, data files, and/or data structures in a non-transitory manner and to provide the computer programs and any associated data, data files, and/or data structures to a processor or computer, so that the processor or computer may execute the computer program. The computer program in the computer readable storage medium may run in an environment deployed in a computer device such as, for example, a terminal, client, host, agent, server, etc. In one example, the computer program and any associated data, data files and/or data structures are distributed on a networked computer system such that the computer program and any associated data, data files and/or data structures are stored, accessed, and/or executed in a distributed manner by one or more processors or computers.

The method for model training, the host, and the storage apparatus according to example embodiments of the present disclosure, use the data offloading between the GPU and the storage apparatus to solve the “memory wall” problem of the GPU and use the data prefetching to accelerate the model training which achieves better training throughput, in which less CPU resources and main memory bandwidth are used and robust performance is provided because the GPU and the storage apparatus transfer data through the direct communication, and higher storage capacity and lower cost for large model training are provided with less complexity in software implementation.

While the present disclosure has been particularly shown and described with reference to embodiments thereof, it will be understood by those of ordinary skill in the art that various changes in form and detail may be made therein without departing from the spirit and scope of the present disclosure as defined by the following claims.

1. A method for training a neural network model, the method comprising:
instructing, by a host apparatus to a graphics processing unit (GPU), to load first intermediate data of a current layer of a model from a dynamic random access memory (DRAM) of a storage apparatus into a memory of the GPU, wherein the current layer is a layer of the model for which computation is being performed; and
notifying, the host apparatus to the storage apparatus, to prefetch second intermediate data of a layer of the model to be computed from NAND of the storage apparatus into the DRAM of the storage apparatus based on a space capacity of the DRAM,
wherein the first intermediate data of the current layer is used by the GPU in backward propagation of the model to perform the computation for the current layer.

2. The method of claim 1, wherein the prefetching of the second intermediate data is performed at least partially in parallel with the computation for the current layer.

3. The method of claim 1, wherein the instructing the storage apparatus to prefetch the second intermediate data comprises:
traversing the layer of the model to be computed as a prefetch layer, and
notifying the storage apparatus to prefetch the second intermediate data for the prefetch layer based on the DRAM having remaining space and the prefetching of the second intermediate data having not been performed for the prefetch layer.

4. The method of claim 1, further comprising:
instructing, in forward propagation of the model, the GPU to offload third intermediate data generated by the computation for the layer of the model from the memory of the GPU into the NAND of the storage apparatus.

5. The method of claim 4, further comprising:
obtaining, prior to model training, information of the layer for which the third intermediate data is offloaded into the NAND based on memory capacity of the GPU and execution time of the forward propagation,
wherein the layer is one of a plurality of layers of the model;
wherein the instructing of the GPU to offload the third intermediate data in the forward propagation of the model comprises:
instructing, in the forward propagation of the model based on the information of the layer, the GPU to offload the third intermediate data.

6. The method of claim 5, wherein the obtaining of the information of the layer for which the third intermediate data is offloaded into the NAND based on the memory capacity of the GPU and the execution time of the forward propagation comprises:
deriving the information of the layer based on a total amount of remaining intermediate data being less than or equal to the memory capacity of the GPU and a total offloading time being less than or equal to the execution time of the forward propagation,
wherein the total amount of the remaining intermediate data is based on an amount of fourth intermediate data of layers of the plurality of layers of the model other than the layer for which the third intermediate data is offloaded into the NAND, and
wherein the total offloading time is based on offloading time of the layer for which the third intermediate data is offloaded into the NAND.

7. The method of claim 1, wherein the first intermediate data comprises activation values, and the computation for the current layer comprises gradient computation with respect to the activation values.

8. A method for training neural network model, the method comprising:
receiving, by a storage apparatus, a notification for performing a data prefetching operation from a host, wherein the storage apparatus comprises a dynamic random access memory (DRAM) and NAND, and
prefetching, by the storage apparatus, intermediate data of a layer of a model to be computed from the NAND into the DRAM based on the received notification.

9. The method of claim 8, wherein the method further comprises:
transmitting intermediate data of a current layer of the model to a memory of a graphics processing unit (GPU), wherein the current layer of the model is a layer of the model for which computation is being performed,
wherein the intermediate data of the current layer is stored in the DRAM, and
wherein the intermediate data of the current layer is used by the GPU in backward propagation of the model to perform the computation for the current layer.

10. The method of claim 9, wherein the prefetching of the intermediate data of the layer and the computation for the current layer are performed at least partially in parallel.

11. The method of claim 9, wherein the intermediate data of the layer of the model to be computed is a first intermediate data of the layer, and wherein the method further comprises:
receiving, in forward propagation of the model, second intermediate data of the layer, the second intermediate data of the layer being data generated by the computation for the layer of the model offloaded from the memory of the GPU to be stored into the NAND.

12. The method of claim 11, wherein the transmitting of the intermediate data of the current layer comprises:
transmitting, based on a compute express link (CXL) protocol, the intermediate data of the current layer stored in the DRAM to the memory of the GPU;
wherein the receiving of the second intermediate data of the layer comprises:
receiving, based on the CXL protocol, the second intermediate data of the layer that is generated by the computation offloaded from the memory of the GPU to be stored into the NAND.

13. The method of claim 9, wherein the storage apparatus further comprises a memory-semantics solid state drive (MS SSD).

14. A host, comprising:
a memory storing instructions; and
a processor configured to execute the instructions to:
instruct a graphics processing unit (GPU) to load first intermediate data of a current layer of a model from a dynamic random access memory (DRAM) of a storage apparatus into a memory of the GPU, wherein the current layer is a layer of the model for which computation is being performed; and
notify, based on space capacity of the DRAM, the storage apparatus to prefetch second intermediate data of a layer of the model to be computed from NAND of the storage apparatus into the DRAM,
wherein the first intermediate data of the current layer is used by the GPU in backward propagation of the model to perform the computation for the current layer.

15. The host of claim 14, wherein the prefetching the second intermediate data of the layer and the computation for the current layer are performed at least partially in parallel.

16. The host of claim 14, wherein the processor is further configured to execute the instructions to:
traverse the layer of the model to be computed as a prefetch layer, and
notifying the storage apparatus to prefetch the second intermediate data for the prefetch layer based on the DRAM having remaining space and the prefetching of the second intermediate data having not been performed for the prefetch layer.

17. The host of claim 14, wherein the processor is further configured to execute the instructions to:
instruct, in forward propagation of the model, the GPU to offload third intermediate data generated by the computation for the layer of the model from the memory of the GPU into the NAND.

18. The host of claim 17, wherein the processor is further configured to execute the instructions to:
obtain, prior to model training, information of the layer for which the third intermediate data is offloaded into the NAND based on memory capacity of the GPU and execution time of the forward propagation, wherein the layer is one of a plurality of layers of the model;
instruct, in the forward propagation of the model based on the information of the layer, the GPU to offload the third intermediate data.

19. The host of claim 18, wherein the processor is further configured to execute the instructions to:
derive the information of the layer based on a total amount of remaining intermediate data being less than or equal to the memory capacity of the GPU and a total offloading time being less than or equal to the execution time of the forward propagation,
wherein the total amount of the remaining intermediate data is based on an amount of fourth intermediate data of layers of the plurality of layers of the model other than the layer for which the third intermediate data is offloaded into the NAND, and
wherein the total offloading time is based on offloading time of the layer for which the third intermediate data is offloaded into the NAND.

20. The host of claim 14, wherein the first intermediate data comprises activation values, and the computation for the current layer comprises gradient computation with respect to the activation values.

21-30. (canceled)
